(19) United States
(12) Patent Application Publication
(10) Pub. No.: US 2005/0217031 A1
(43) Pub. Date: Oct. 6, 2005

(54) Universal clutch puller and installer

(76) Inventor: James Edward Carlson, Troy, MI (US)

Correspondence Address: James Edward Carlson, 584 Hidden Ridge, Troy, MI, 48083, US

(21) Appl. No.: 10/442,901

(22) Filed: Apr. 5, 2004

(51) Int. Cl. B25F 1/00

(52) U.S. Cl. 7/100

(57) ABSTRACT

The materials needed for making the universal clutch puller and installer (UCPI) consist of flat steel stock and metal pins. After outlining, cutting, drilling, and bending you will end up with a device that makes the installation and removal of clutches easier on motorcycles and small engines with the three shoe clutch system. It cut my install/removal time from 1 ½ hours to approximately fifteen minutes. As you can see in the drawings this device is 14 ½″ inches long, 1 ⅜″ inches wide and ¼″ inch high.

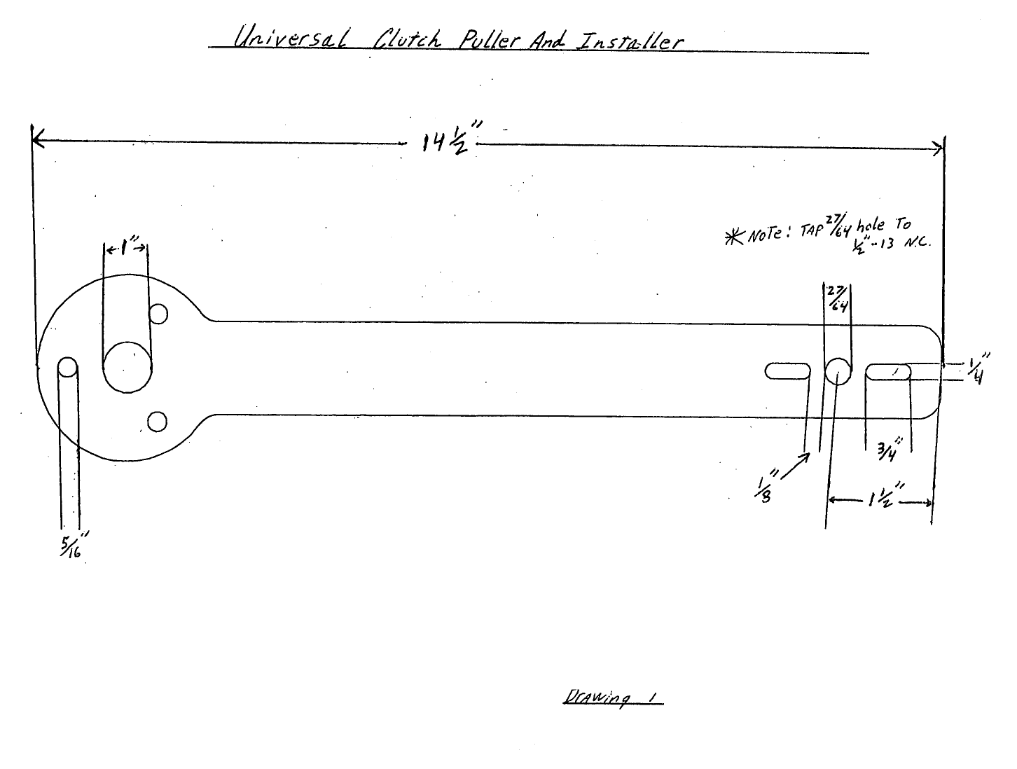

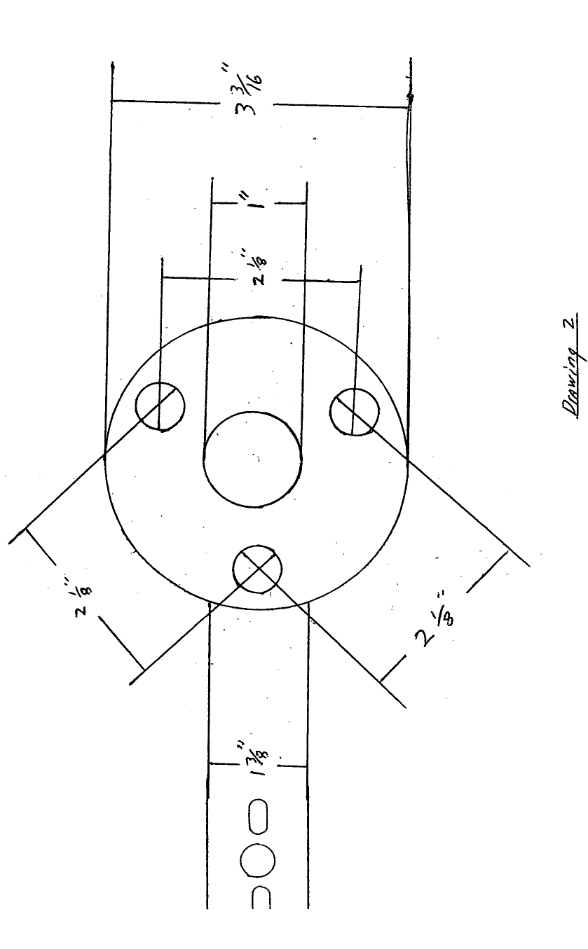

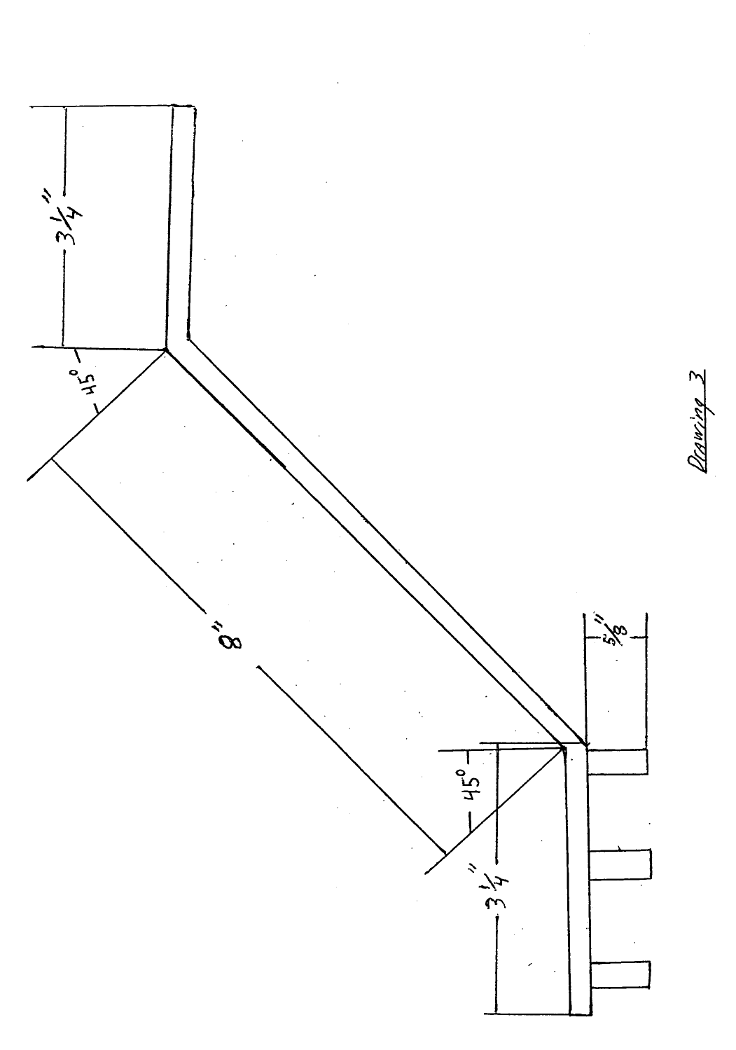

### DETAILED DESCRIPTION OF THE INVENTION

Making of the Universal Clutch Puller and Installer (UCPI):

To make the universal clutch puller and installer (UCPI) you will need flat steel stock (¼″×4″×14½″). Place clutch on one end of flat stock and outline the outside of the clutch. Do not forget to outline in between the clutch shoes. This is where your three (3) pins will be located on your clutch tool (refer to left side of drawing 1 of 3). On the other end of the flat stock measure 1 5/16″ from the top and 1 5/16″ from the bottom. You should have 1 ⅜″ in the middle. Draw your middle lines all the way down your flat stock until you run into your outline of the clutch. From the end of your flat stock, cut one of your middle lines heading towards your outline of the clutch. Continue to cut around the outside of your clutch outline until you get to the other middle line. Then continue cutting the middle line to the end of the flat stock. Next measure across your clutch outlines and find the center. Drill the center to 1″ in diameter all the way through. Then measure from the center out to your pins. Your pins will go in between the clutch shoes and should measure 2 1/18″ from each other (refer to drawing 2 of 3). Drill your three (3) pin holes 5/16″ all the way through. Your metal dowel pins should be ⅞″ in length and 0.358 inches in diameter. Then proceed to press your pins through so that one side is flush with that of the flat stock (refer to left side of drawing 3 of 3). On the other end, measure 11/16″ from the top or bottom and make a mark and then measure from the end of the flat stock over ½″. From that mark drill through the flat stock with a ¼″ end mill bit. Using that bit, mill the flat stock ¾″ towards the clutch end. At the end of that hole, measure a ¼″ and drill a hole using a 27/64″ drill bit. Then tap that hole with a ½″ 13 n.c. (national coarse) tap. From that center hole measure across a ¼″ and drill with a ¼″ end mill bit through the flat stock and milling that hole ¾″ across towards the clutch end of the flat stock (refer to right side of drawing 1 of 3). Place the tool in the middle of a vise, clamping on the outside edges. Measure from each end 3 ¼″ towards the middle. On the end that is 1 ⅜″ across, heat metal with a torch and bend flat stock down 45 degrees. On the other end heat with a torch and bend the opposite direction towards the sky (refer to drawing 3 of 3). Now your tool is complete.

Using the Universal Clutch Puller and Installer (UCPI):

First you will have to drain the oil from the motor. Then you will remove the side cover to expose the clutch. Insert the clutch puller into the clutch by inserting the three (3) pins on the clutch puller in between the clutch shoes. You will then brace puller on top of foot peg if working on a motorcycle. Insert the proper size socket onto center nut through the 1″ hole in the center of the puller. Loosen nut counter clockwise until nut is completely off. Turn puller around and insert the two proper size bolts through slotted holes in the clutch puller and into the clutch. Hold the clutch puller firmly with one hand and tighten the center bolt on the clutch puller against the center stud in which the clutch sits on. Tighten the bolt until the clutch pops off. Complete any necessary repairs to the clutch and then reinstall the clutch. To reinstall the clutch, insert the clutch onto the center stud. Then install nut onto stud by turning it clockwise until snug. Insert the three (3) studs of the clutch installer in between the clutch shoes. Then insert socket through the 1″ hole in the center of the clutch installer. Firmly hold the clutch installer with one hand and tighten the center nut to the recommended torque from the manufacturer. Remove the socket and clutch installer from engine. Finally reinstall the side cover and do not forget to add the correct amount of oil to the engine.

### SPECIFICATION

I designed the universal clutch puller and installer to make the removal and installation of the clutch easier and faster. My tool is designed to work on a three shoe clutch system that is generally found on motorcycles and small engines of various makes and models.

### BACKGROUND

After trying different tools and many frustrating hours installing and removing clutches on motorcycles, I came up with the idea for the universal clutch puller and installer. One tool that would work for both removing and installing clutches on motorcycles and even on some small engines.

### BRIEF SUMMARY OF THE INVENTION

I designed the universal clutch puller and installer to make the removal and installation of the clutch easier and faster. This tool is designed to work on a three shoe clutch system that is generally found on motorcycles and small engines of various makes and models. I have outlined how to use and the making of this tool in the Detailed Description Of The Invention document.

### BRIEF DESCRIPTION OF THE SEVERAL VIEWS OF THE DRAWINGS

Picture 1 of 3: This drawing is a view looking down at the device. This drawing also shows the complete layout of where all the holes should be cut and drilled on the device.

Picture 2 of 3: This drawing is a view of one end that shows the measurements of each hole.

Picture 3 of 3: This drawing is a drawing looking at the product from the side. It shows the angle degree of metal and shows the height of the three (3) pins.

1. I claim the universal clutch puller and installer makes the removal and installation of the clutch easier and faster.
